(19) United States
(12) Patent Application Publication
(10) Pub. No.: US 2010/0208421 A1
(43) Pub. Date: Aug. 19, 2010

(54) BIKE COMPUTER HAVING DUAL POWER SOURCE

(76) Inventors: Yung-Hung CHIH, Shulin City (TW); Ching-Wen Yeh, Shulin City (TW)

Correspondence Address: Muncy, Geissler, Olds & Lowe, PLLC, 4000 Legato Road, Suite 310, FAIRFAX, VA, 22033, US

(21) Appl. No.: 12/372,461

(22) Filed: Feb. 17, 2009

(51) Int. Cl. G06F 1/16

(52) U.S. Cl. 361/679.26

(57) ABSTRACT

A bike computer having dual power source comprises a housing, a first power module, a switch module and a second power module. The housing has a control module, a liquid display module and a light source module. The control module is electrically connected to the liquid display module, and the light source module provides lights to the liquid display module. A first power module is electrically connected to the control module to supply power to the control module; the switch module is electrically connected to the control module, the first power module, and the light source module. A second power module is electrically connected to the switch module, where is controllable by the control module to switch power outputting for the light source module from the first power module to the second power module.

### FIELD OF THE INVENTION

The present invention relates to a bike computer, particularly, to a bike computer having auxiliary electrical power for a light source module to reduce the electrical power consumption of the power module.

### BACKGROUND

Recently bike computers have been constantly developed and mounted with various microelectronic components to simultaneously gather and display rotational information of the bicycle to fulfill the increasing needs of a rider during bicycle riding (e.g. by displaying various information to the rider such as time, elapsed time, speed, travelled distance, average speed and the like). An integrated backlight source is disposed inside some conventional bike computers for bikers to easily read the information displayed by the bike computers, especially at nights or when the visibility is poor.

As shown in FIG. 3, while a conventional multifunction bike computer uses an integrated mercury battery as its power source, the backlight source will expedite the electrical power consumption except that the complicated interface of the bike computer will consume quite a bit of electrical power. Unfortunately, the integrated mercury batteries of such bike computers are sold at higher price in the market and difficult to replace. Therefore, the bike computers and its backlight may fail at an undesirable time, and the practicability of the bike computers is limited accordingly due to the aforementioned drawbacks.

In view of the above, it will be apparent to those skilled in the art from this disclosure that there exists a need for an improved bike computer, which assure sufficient electrical power for the light source module during usage to make bike computers function normally and work longer. This invention addresses this need in the art as well as other needs, which will become apparent to those skilled in the art from this disclosure.

### SUMMARY OF THE INVENTION

The primary object of the present invention is to provide a bike computer having dual power source, wherein a light source module is electrically connected to a second power module to supply auxiliary electrical power to the light source module for illuminating the liquid display module and reducing the electrical power consumption of a first power module.

In order to achieve the aforementioned object, the bike computer of the present invention having dual power source comprises a housing, a first power module, a switch module and a second power module. The housing has a control module, a liquid display module and a light source module that are disposed in the housing, wherein the control module is electrically connected to the liquid display module, and the light source module provides lights to the liquid display module. The first power module is disposed inside the housing for being electrically connected to the control module to supply power to the control module. The switch module is electrically connected to the control module, the first power module and the light source module; the first power module supplies power to the light module via the switch module; the second power module is electrically connected to the switch module, the switch module is controllable by the control module and can switch power of the second power module to the light source module.

Other objects, advantages and novel features of the present invention will become more apparent from the following detailed description when taken in conjunction with the accompanying drawings.

### BRIEF DESCRIPTION OF THE DRAWINGS

FIG. 1 shows a block diagram of a preferred embodiment according to the present invention.

FIG. 2 is a perspective view of another preferred embodiment showing a bike computer with an external power device according to the present invention.

FIG. 3 is a block diagram of a conventional bike computer.

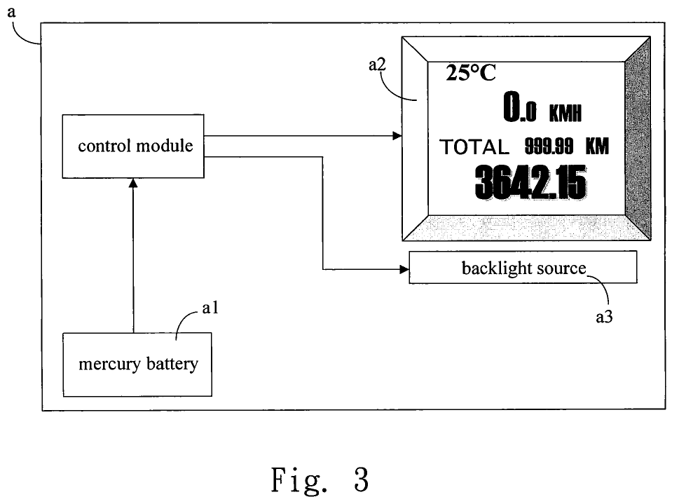

### DETAILED DESCRIPTION

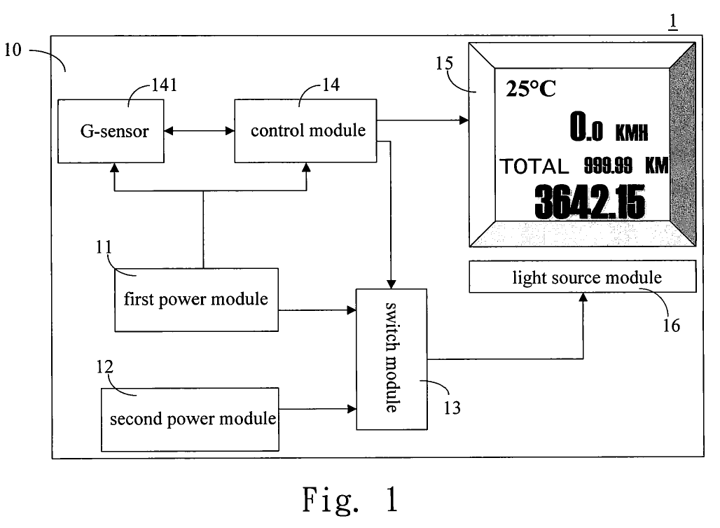

Referring to FIG. 1, a bike computer having dual power source 1 of a preferred embodiment of the present invention is illustrated, wherein the bike computer comprises a housing 10, a first power module 11, a second power module 12 and a switch module 13. The housing 10 includes a control module 14, a liquid display module 15 and a light source module 16 which are disposed inside the housing 10; the control module 14 is electrically connected to the switch module 13 and the liquid display module 15 separately.

The first power module 11 is disposed inside the housing 10 and electrically connected to the control module 14 and the switch module 13 for providing electrical power to the control module 14 and the switch module 13. In this embodiment, the first power module 11 comprises a mercury battery or a button cell as the power supply.

The switch module 13 is disposed inside the housing 10 and electrically connected to the control module 14, the first power module 11 and the light source module 16; the switch module receives a control signal from the control module 14 to supply electrical power of the first power module 11 to the light source module 16 for turning on the light source module 16.

The second power module 12 is disposed inside the housing 10 and has a battery holding portion, and a battery positioned in the battery holding portion (not shown) is electrically connected to the switch module 13. In the present preferred embodiment, the battery is preferably a commonly used AA or AAA battery electrically connected to the switch module 13 for supplying electric power to the light source module 16.

In practice, the housing 10 is positioned with at least one control button for bicyclists to operate the bike computer and select information displayed on the liquid display module 15 by repetitively pressing the control button. The control module 14 generates a control signal to the switch module 13 while bicyclists press the control button, and then the switch module 13 turns on the second power module 12 for supplying electrical power to the light source module 16. Once the battery of the second power module 12 is depleted or there is no battery in the battery holding portion, the control module 14 controls the switch module 13 to actuate the first power module 11, the battery of the first power module 11 supplies power to the light source module 16; further, the switch module 13 preferably turns off the electric power from the first power module 11 to the light source module 16 after a predetermined time (e.g., 3 seconds) to reduce the power consumption of the first power module 11.

In another embodiment of the present invention, the control module 14 further comprises a G sensor 141 (an accelerometer) that controls the bike computer. While the G sensor 141 automatically measures acceleration and gravity induced reaction forces, it simultaneously turns on the power of the bike computer, and it can turn off the power when the bike computer remains motionless for a predetermined time to save electric power of the bike computer. Further, the control module 14 can also uses the G sensor 141 to gather a variety of information, such as elapsed time, speed, travelled distance, and the like.

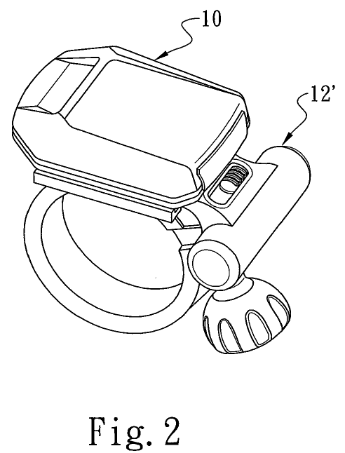

Referring to FIG. 2, the second power module 12′ of the present invention can also be an external power device disposed in the exterior of the housing 10, such that the battery within the battery holding portion of the second power module 12′ is easy to replace by users.

Therefore, the present invention has the following advantages:

1. The switch module of the present invention can optimize a rational configuration of electric power to reduce the electric power consumption of the first power module by an auxiliary electrical power and to enhance the durability and stability of the control module.

2. The present invention can prolong the usage time of mercury battery by reducing the power consumption of the mercury battery, and therefore save the cost of maintaining the bike computer.

3. The second power module of the present invention is designed for users to easily replace the battery of the second power module when the electric power for the light source module is not sufficient.

4. The present invention can uses a G sensor as a power switch and a collector of variety of information during bicycle riding to achieve creativity and enhance its practicability.

As stated in the above disclosed, the present invention can surely achieve its expected objects to provide a bike computer having dual power source with sufficient electrical power for the light source module during usage and low cost of maintaining for people to easily replace the battery for light source module.

It should be understood that different modifications and variations could be made from the disclosures of the present invention by the people familiar in the art without departing the spirit of the present invention.

What is claimed is:

1. A bike computer having dual power source, comprising:
a housing having a control module, a liquid display module and a light source module disposed in the housing, wherein the control module is electrically connected to the liquid display module, and the light source module provides lights to the liquid display module;
a first power module disposed inside the housing for being electrically connected to the control module to supply power to the control module;
a switch module being electrically connected to the control module, the first power module and the light source module for the first power module to supplies power to the light module via the switch module; and
a second power module electrically connected to the switch module, the switch module being controllable by the control module to switch power outputting for the light source module from the first power module to the second power module.

2. The bike computer having dual power source according to claim 1, wherein the control module further comprises a G sensor.

3. The bike computer having dual power source according to claim 1, wherein the switch module and the second power module are disposed inside the housing.
